(19) United States
(12) Patent Application Publication
(10) Pub. No.: US 2023/0048929 A1
(43) Pub. Date: Feb. 16, 2023

(54) PARALLEL SIMULATION QUALIFICATION WITH PERFORMANCE PREDICTION

(71) Applicant: Siemens Industry Software Inc., Plano, TX (US)

(72) Inventors: Rohit Kumar Jain, Milpitas, CA (US); Jayvant Padmanabha Anantpur, Beaverton, OR (US); Devon J. Kehoe, Tualatin, OR (US); Vikas Sangal, Fremont, CA (US)

(21) Appl. No.: 17/398,070

(22) Filed: Aug. 10, 2021

(51) Int. Cl. G06F 30/3312; G06F 30/398; G06F 30/337; G06F 30/3323

(52) U.S. Cl. CPC G06F 30/3312; G06F 30/398; G06F 30/337; G06F 30/3323; G06F 30/31

(57) ABSTRACT

A simulator can simulate a circuit design describing an electronic device using a single processing device of a computing system. The simulator can generate profile data associated with compilation of the circuit design and the single processing device simulation of the compiled circuit design. The profile data can identify multiple different ways to partition the circuit design and include information corresponding to the single processing device simulation of the compiled circuit design. A parallel simulation qualifier can determine a parallelism factor corresponding to an expected performance of the computing system in a multiple processing device simulation of the circuit design based on the profile data from the single processing device simulation of the circuit design. The simulator can utilize the parallelism factor to partition the circuit design in one of the different ways, and simulate the partitioned circuit design with multiple processing devices of the computing system.

### TECHNICAL FIELD

This application is generally related to electronic design automation and, more specifically, to parallel simulation qualification with performance prediction.

### BACKGROUND

Designing and fabricating electronic systems typically involves many steps, known as a “design flow.” The particular steps of a design flow often are dependent upon the type of electronic system to be manufactured, its complexity, the design team, and the fabricator or foundry that will manufacture the electronic system from a design. Initially, a specification for a new electronic system can be transformed into a logical design, sometimes referred to as a register transfer level (RTL) description of the electronic system. With this logical design, the electronic system can be described in terms of both the exchange of signals between hardware registers and the logical operations that can be performed on those signals. The logical design typically employs a Hardware Design Language (HDL), such as SystemVerilog or Very high speed integrated circuit Hardware Design Language (VHDL).

The logic of the electronic system can be analyzed to confirm that it will accurately perform the functions desired for the electronic system, sometimes referred to as “functional verification.” Design verification tools can perform functional verification operations, such as simulating, emulating, and/or prototyping the logical design. For example, when a design verification tool simulates the logical design, the design verification tool can provide transactions or sets of test vectors, for example, generated by a simulated test bench, to the simulated logical design. The design verification tools can determine how the simulated logical design responded to the transactions or test vectors, and verify, from that response, that the logical design describes circuitry to accurately perform functions.

As the logical designs increase in size and verification runtime becomes longer, one technique used to speed-up functional verification includes implementing multiple processing device or multi-core parallel simulation. Applying multi-core parallel processing in functional simulation, however, can be difficult given the varying nature of logical designs, cache or memory activity levels during parallel simulation, or the like. This added difficulty can translate into time and effort to set up a design environment to be able to run multi-core parallel simulation on a logical design that was traditionally been run on single-core. While some logical designs, due to their configuration, can be sped-up through the implementation of multi-core parallel simulation, not all logical designs similarly benefit from parallel simulation. Some logical designs can run slower in a multi-core simulation than with a traditional single-core simulation, which renders the considerable time and effort spent on setting-up parallel simulation left unrewarded.

### SUMMARY

This application discloses a computing system implementing a simulator to simulate a circuit design describing an electronic device using a single processing device of a computing system. The simulator can have a qualifier mode that, when activated, can generate profile data associated with compilation of the circuit design and the single processing device simulation of the compiled circuit design. The profile data can identify multiple different ways to partition the circuit design and include information corresponding to the single processing device simulation of the compiled circuit design. A parallel simulation qualifier can determine a parallelism factor corresponding to an expected performance of the computing system in a multiple processing device parallel simulation of the circuit design based on the profile data from the single processing device simulation of the circuit design. The simulator can utilize the parallelism factor to partition the circuit design in one of the different ways, and simulate the partitioned circuit design with multiple processing devices of the computing system. Embodiments will be described in greater detail below.

### DESCRIPTION OF THE DRAWINGS

FIGS. 1 and 2 illustrate an example of a computer system of the type that may be used to implement various embodiments.

FIG. 3 illustrates an example design verification system having a parallel simulation qualification system that may be implemented according to various embodiments.

FIG. 4 illustrates an example parallel simulation qualification system to generate a performance prediction for parallel simulation of a circuit design, which may be implemented according to various embodiments.

FIG. 5 illustrates an example flowchart implementing performance prediction for parallel simulation of a circuit design, which may be implemented according to various embodiments.

### DETAILED DESCRIPTION

### Illustrative Operating Environment

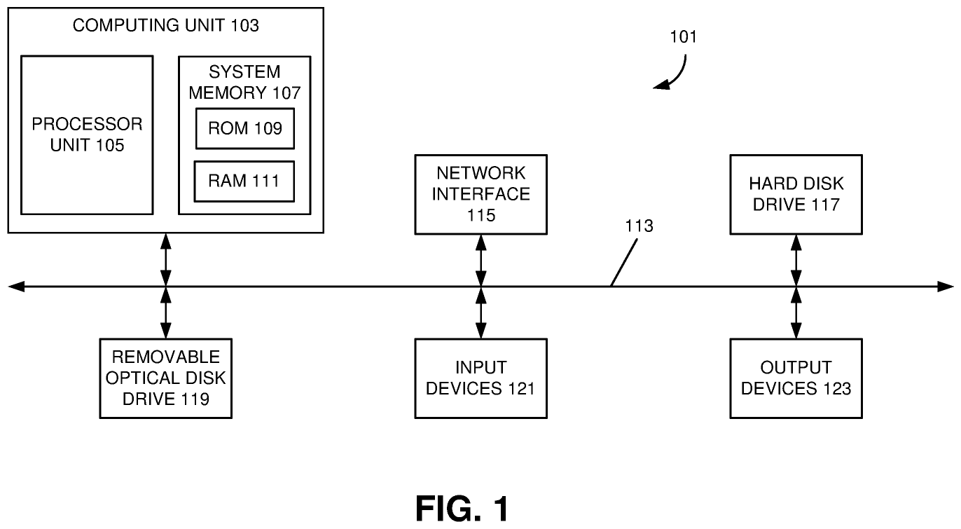

Various embodiments may be implemented through the execution of software instructions by a computing device 101, such as a programmable computer. Accordingly, FIG. 1 shows an illustrative example of a computing device 101. As seen in this figure, the computing device 101 includes a computing unit 103 with a processing unit 105 and a system memory 107. The processing unit 105 may be any type of programmable electronic device for executing software instructions, but will conventionally be a microprocessor. The system memory 107 may include both a read-only memory (ROM) 109 and a random access memory (RAM) 111. As will be appreciated by those of ordinary skill in the art, both the read-only memory (ROM) 109 and the random access memory (RAM) 111 may store software instructions for execution by the processing unit 105.

The processing unit 105 and the system memory 107 are connected, either directly or indirectly, through a bus 113 or alternate communication structure, to one or more peripheral devices 117-123. For example, the processing unit 105 or the system memory 107 may be directly or indirectly connected to one or more additional memory storage devices, such as a hard disk drive 117, which can be magnetic and/or removable, a removable optical disk drive 119, and/or a flash memory card. The processing unit 105 and the system memory 107 also may be directly or indirectly connected to one or more input devices 121 and one or more output devices 123. The input devices 121 may include, for example, a keyboard, a pointing device (such as a mouse, touchpad, stylus, trackball, or joystick), a scanner, a camera, and a microphone. The output devices 123 may include, for example, a monitor display, a printer and speakers. With various examples of the computing device 101, one or more of the peripheral devices 117-123 may be internally housed with the computing unit 103. Alternately, one or more of the peripheral devices 117-123 may be external to the housing for the computing unit 103 and connected to the bus 113 through, for example, a Universal Serial Bus (USB) connection.

With some implementations, the computing unit 103 may be directly or indirectly connected to a network interface 115 for communicating with other devices making up a network. The network interface 115 can translate data and control signals from the computing unit 103 into network messages according to one or more communication protocols, such as the transmission control protocol (TCP) and the Internet protocol (IP). Also, the network interface 115 may employ any suitable connection agent (or combination of agents) for connecting to a network, including, for example, a wireless transceiver, a modem, or an Ethernet connection. Such network interfaces and protocols are well known in the art, and thus will not be discussed here in more detail.

It should be appreciated that the computing device 101 is illustrated as an example only, and it not intended to be limiting. Various embodiments may be implemented using one or more computing devices that include the components of the computing device 101 illustrated in FIG. 1, which include only a subset of the components illustrated in FIG. 1, or which include an alternate combination of components, including components that are not shown in FIG. 1. For example, various embodiments may be implemented using a multi-processor computer, a plurality of single and/or multiprocessor computers arranged into a network, or some combination of both.

With some implementations, the processor unit 105 can have more than one processor core. Accordingly, FIG. 2 illustrates an example of a multi-core processor unit 105 that may be employed with various embodiments. As seen in this figure, the processor unit 105 includes a plurality of processor cores 201A and 201B. Each processor core 201A and 201B includes a computing engine 203A and 203B, respectively, and a memory cache 205A and 205B, respectively. As known to those of ordinary skill in the art, a computing engine 203A and 203B can include logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203A and 203B may then use its corresponding memory cache 205A and 205B, respectively, to quickly store and retrieve data and/or instructions for execution.

Each processor core 201A and 201B is connected to an interconnect 207. The particular construction of the interconnect 207 may vary depending upon the architecture of the processor unit 105. With some processor cores 201A and 201B, such as the Cell microprocessor created by Sony Corporation, Toshiba Corporation and IBM Corporation, the interconnect 207 may be implemented as an interconnect bus. With other processor units 201A and 201B, however, such as the Opteron™ and Athlon™ dual-core processors available from Advanced Micro Devices of Sunnyvale, Calif., the interconnect 207 may be implemented as a system request interface device. In any case, the processor cores 201A and 201B communicate through the interconnect 207 with an input/output interface 209 and a memory controller 210. The input/output interface 209 provides a communication interface to the bus 113. Similarly, the memory controller 210 controls the exchange of information to the system memory 107. With some implementations, the processor unit 105 may include additional components, such as a high-level cache memory accessible shared by the processor cores 201A and 201B. It also should be appreciated that the description of the computer network illustrated in FIG. 1 and FIG. 2 is provided as an example only, and it not intended to suggest any limitation as to the scope of use or functionality of alternate embodiments.

Parallel Simulation Qualification with Performance Prediction

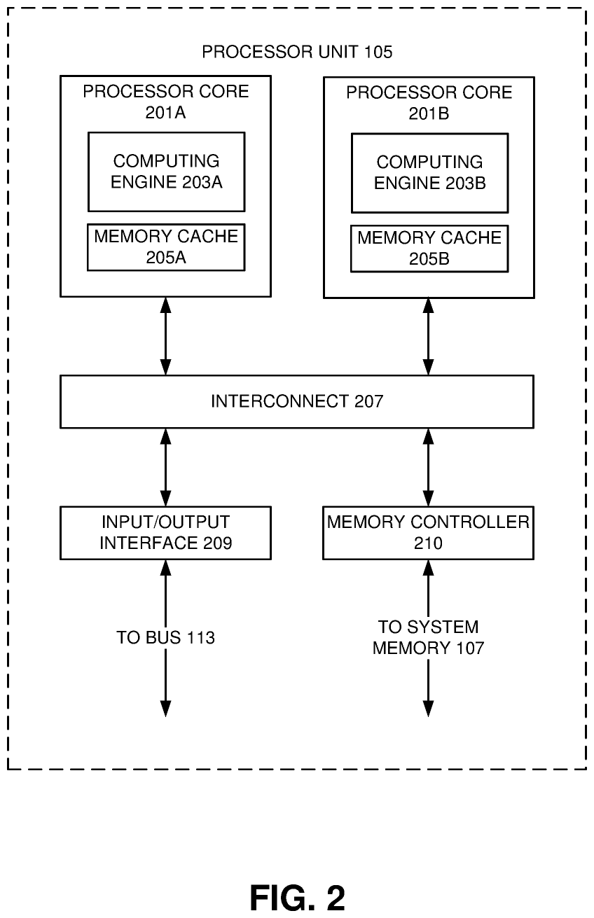

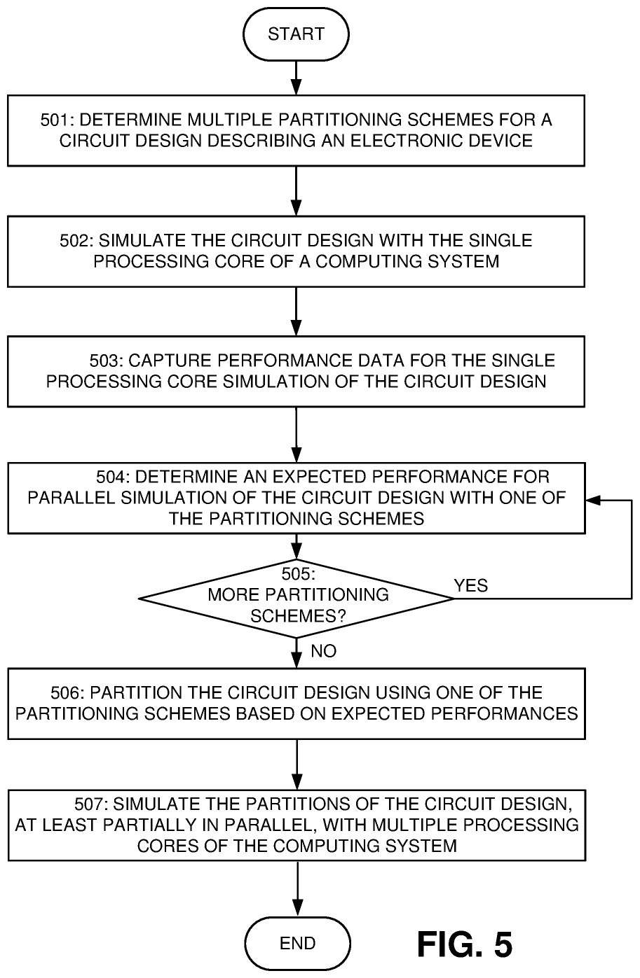

FIG. 3 illustrates an example design verification system 300 having a parallel simulation qualification system 400 that may be implemented according to various embodiments. FIG. 5 illustrates an example flowchart implementing performance prediction for parallel simulation of a circuit design, which may be implemented according to various embodiments. Referring to FIGS. 3 and 5, the design verification system 300 can include a simulator 310, for example, implemented with a computer network 101 described above with reference to FIG. 1, to functionally verify a circuit design 301 describing an electronic device. In some embodiments, the circuit design 301 can describe the electronic device both in terms of an exchange of data signals between components in the electronic device, such as hardware registers, flip-flops, combinational logic, or the like, and in terms of logical operations that can be performed on the data signals in the electronic device. The circuit design 301 can model the electronic device at a register transfer level (RTL), for example, with code in a hardware description language (HDL), such as SystemVerilog, Very high speed integrated circuit Hardware Design Language (VHDL), System C, or the like.

The simulator 310 can utilize a test bench 302 to generate test stimulus during functional verification operations, such as clock signals, activation signals, power signals, control signals, data signals or the like. The test stimulus, when grouped, may form test bench transactions capable of prompting operation of the circuit design 301 being functionally verified by the simulator 310. In some embodiments, the test bench 302 can be written in an object-oriented programming language, for example, SystemVerilog or the like, which, when executed during elaboration, can dynamically generate test bench components for verification of the circuit design. A methodology library, for example, a Universal Verification Methodology (UVM) library, an Open Verification Methodology (OVM) library, an Advanced Verification Methodology (AVM) library, a Verification Methodology Manual (VMM) library, or the like, can be utilized as a base for creating the test bench.

The simulator 310 can include a compiler 312 to compile the circuit design 301 and the test bench 302 into a format compatible for execution during simulation. In some embodiments, the compilation of the circuit design 301 and test bench 302 can vary depending on a number of processing devices, such as different processors, or different processing cores, different computers, or the like, which the simulator 310 intends to utilize during simulation. The simulator 310 can include a selectable simulation system 314 to simulate the circuit design 301 and the test bench 302 with one or more processing devices of a computing system implementing the simulator 310. The selectable simulation system 314 can generate output corresponding to the operations of the circuit design 301 in response to the test stimulus during the functional verification operations, which can be compared to expected output of the circuit design 301.

The simulator 310 can include a parallelism profiler 316 to initiate a parallel simulation qualification mode for the simulator 310, which can prompt the simulator 310 to compile the circuit design 301 for a single processing device simulation and then simulate the compiled circuit design 301. The parallelism profiler 316 can collect data during compilation and simulation and generate the profile data files 303 based on the collected data.

The compiler 312, in a block 501, can determine multiple partitioning schemes for the circuit design 301. In some embodiments, the parallelism profiler 316 can prompt the compiler 312 to identify multiple different approaches or schemes to partition the circuit design 301, while compiling the circuit design 301 for the single processing device simulation by the simulator 310. For example, the compiler 312 can identify one or more types of constructs in the circuit design 301, such as complex-type module ports, hierarchical references to complex-type modules, foreign language interfaces, or the like, which can reduce or inhibit partitioning of the circuit design 301. The parallelism profiler 316 can collect the different approaches to partition the circuit design 301 identified by the compiler 312, which can include a number of partitions of the circuit design 301 and locations of the partitioning in the circuit design 301. Since each partition of the circuit design 301 would correspond to simulation by a different processing device of the simulator 310 in parallel, the parallelism profiler 316 can prompt the compiler 312 to identify the different approaches to partition the circuit design 301 based on the number of processing devices available in the selectable simulation system 314.

The parallelism profiler 316 also can prompt the compiler 312 to determine weightings for the partitions, called RTL weights, which corresponds to estimates of simulation loads for each of the partitioning schemes and each of the partitions in the partitioning schemes. In some embodiments, the parallelism profiler 316 can perform a static analysis on each partition in each partitioning scheme to estimate separate simulation overheads for the partitions and to identify a number and a size of ports located on the boundaries of the partitions.

The selectable simulation system 314 in the simulator 310, in a block 502, can simulate the complied circuit design 301 with a single processing device of the computing system. The parallelism profiler 316, in a block 503, can capture performance data for the single processing device simulation of the circuit design 301. During the single processing device simulation of the compiled circuit design 301 by the simulator 310, the parallelism profiler 316 can capture data corresponding to event regions of the circuit design simulation. In some embodiments, the simulator 310 can utilize an event queue for each of the event regions, which can dictate ordering of process evaluation during the simulation, and collect data corresponding to when the event queues become activated during the simulation. The parallelism profiler 316 also can capture data corresponding to simulation activity, such as an activation of processes or implementation of triggers of the circuit design 301. In some embodiments, the processes can correspond to one or more design blocks in the circuit design 301, while the triggers can correspond to change activity in the circuit design 301, such as a change in an output value or change of state in the circuit design 301, for example, which can prompt evaluation of one or more of the processes. The parallelism profiler 316 can identify a number of processes or triggers activated in the simulation of the circuit design 301, identify when different partitions of the circuit design 301 in the different partitioning schemes activate concurrently during the simulation, or the like. The parallelism profiler 316 also can capture data corresponding to ports associated with boundaries of the partitions in the circuit design 301.

The parallelism profiler 316 can utilize the data collected during the compilation, such as the partitioning schemes and the RTL weights, and the data collected during simulation of the circuit design, such as the event queues, execution frequency and concurrency of processes and trigger, and ports between partitions of circuit design 301, to generate the profile data files 303. The parallelism profiler 316 can store the profile data files 303 in a database 320, for example, after the selectable simulation system 314 has completed a verification run of the circuit design 301 using a single processing device of the computing system. Although the database 320 is shown in FIG. 3 to be external to the simulator 310, in some embodiments, the simulator 310 can include the database 320.

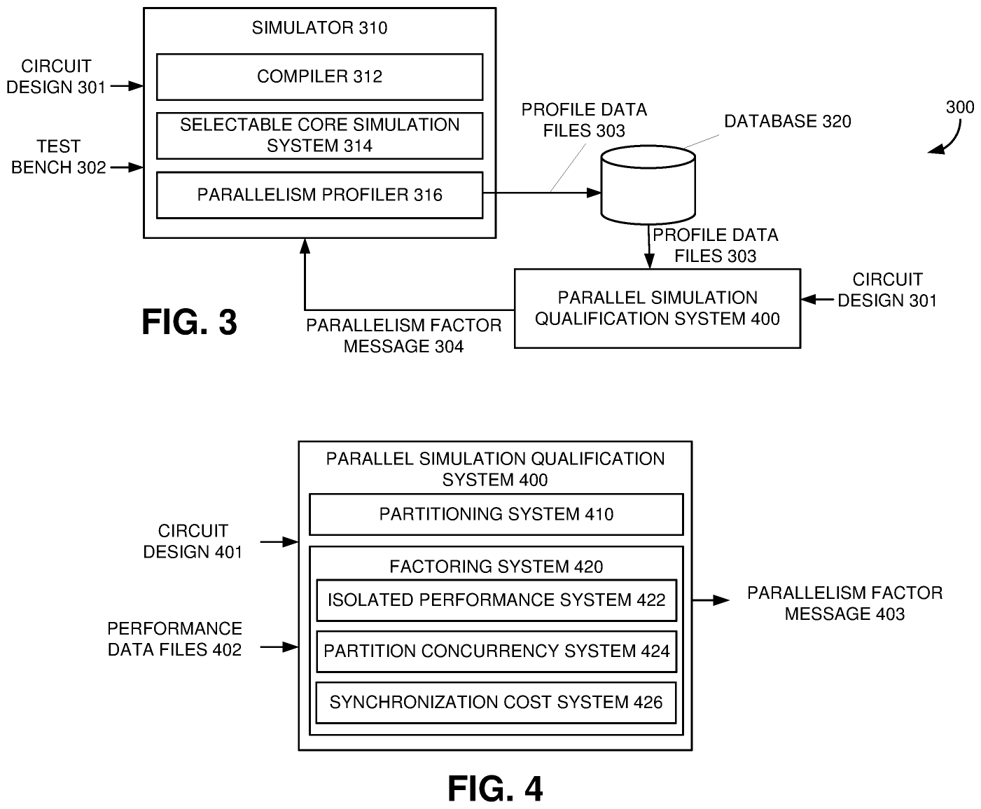

The design verification system 300 can include a parallel simulation qualification system 400, for example, implemented with a computer network 101 described above with reference to FIG. 1, to receive the profile data files 303 from the database 320. The parallel simulation qualification system 400, in a block 504, can determine an expected performance for parallel simulation of the circuit design 301 with one of the partitioning schemes based on the profile data files 303. In some embodiments, the parallel simulation qualification system 400 can analyze the partitions of the circuit design 301 to determine a raw performance for a parallel simulation and then modify the raw performance to determine the expected performance of parallel simulation using the partitioning scheme by factoring in any performance reductions due to a lack of complete simulation concurrency between the multiple processing devices and performance costs to synchronize data between the processing devices. Embodiments of the parallel simulation qualification system 400 will be described below with reference to FIG. 4 in greater detail.

FIG. 4 illustrates an example parallel simulation qualification system 400 to generate a performance prediction for parallel simulation of a circuit design, which may be implemented according to various embodiments. Referring to FIG. 4, the parallel simulation qualification system 400 can receive a circuit design 401 describing an electronic device both in terms of an exchange of data signals between components in the electronic device, such as hardware registers, flip-flops, combinational logic, or the like, and in terms of logical operations that can be performed on the data signals in the electronic device. The circuit design 401 can model the electronic device at a register transfer level (RTL), for example, with code in a hardware description language (HDL), such as SystemVerilog, Very high speed integrated circuit Hardware Design Language (VHDL), System C, or the like.

The parallel simulation qualification system 400 also can receive profile data files 402, which can include information about the circuit design 401, for example, collected during compilation and simulation using a single processing device of a computing system. In some embodiments, the data collected during the compilation can include different schemes to partition the circuit design 401 and RTL weights associated with the different partitions in the partitioning schemes. The data collected during simulation can include activity in event queues during the simulation, execution frequency processes and triggers, execution concurrency of processes and triggers, and ports between the partitions of circuit design 401.

The parallel simulation qualification system 400 can include a partitioning system 410 to identify different partitioning schemes for the circuit design 401 and the respective partitions of the circuit design 401 in each of the different partitioning schemes. In some embodiments, the different partitioning schemes for the circuit design 401 can be determined during compilation of the circuit design 401 for simulation using a single processing device of a computing system, which can be included in the profile data files 402 received by the parallel simulation qualification system 400.

The parallel simulation qualification system 400 can include a factoring system 420 to generate a parallelism factor message 403, which can identify at least one of the partitioning schemes that provides a simulation speed-up. The parallelism factor message 403 can include a parallelism factor, which can correspond to an expected or predicted performance of a parallel simulation of the circuit design 401 using multiple processing devices of the computing system implementing a simulator. In some embodiments, the parallelism factor message 403 also can include commands that, when implemented by a simulator, can prompt compilation and parallel simulation of the circuit design 401 with the identified partitioning scheme.

The factoring system 420 can include an isolated performance system 422 to determine a raw performance of a parallel simulation of the circuit design 401 for each partitioning scheme, for example, before taking into consideration synchronization costs of those partitioning schemes. In some embodiments, the isolated performance system 422 can identify a sequence of partitions in the partitioning scheme that corresponds to a critical path, such as the partition having executed a largest number of processes and triggers, and determined the raw performance of the parallel simulation as a performance of the critical path relative to the entire circuit design 401. For example, when the circuit design 401 simulation executes 1000 processes and triggers and the critical path executes 250 processes and triggers, the raw performance can correspond to 4 or 1000 divided by 250. The raw performance of the parallel simulation can correspond to a speed-up of a parallel simulation relative to single processing device simulation before accounting for concurrency and synchronization.

The factoring system 420 can include a partition concurrency system 424 to determine how often partitions execute processes and triggers in parallel based on the concurrent execution information in the profile data files 402. In some embodiments, the partition concurrency system 424 can set a concurrency value based on a level of concurrent execution. For example, when there is no concurrent execution of partitions, the concurrency value can equal 0, and when there is complete concurrency, the concurrency value can equal 1. The factor system 420 can utilize the concurrency value to dampen the raw performance of the parallel simulation determined by the isolated performance system 422.

The factoring system 420 can include a synchronization cost system 426 to determine a fraction of the simulation execution time of the circuit design 401 corresponds to synchronizing data between the different partitions executing on different processing devices of the computing system. The synchronization cost system 426 can utilize the event queues and the port information from the profile data files 402 to identify the fraction of simulation time corresponding to synchronizing data, for example, utilizing linear regression models. The factoring system 420 can aggregate the raw performance of the parallel simulation determined by the isolated performance system 422, the concurrency value determined by the partition concurrency system 424, and the fraction of simulation time corresponding to synchronizing data determined by the synchronization cost system 426 to generate an estimated performance of parallel simulation of the circuit design 401 with the partitioning scheme relative to a performance of a single device simulation of the circuit design 401. The estimated performance can correspond to a parallelism factor for that partitioning scheme. The factoring system 420 can repeat the process for each partitioning scheme, for example, generating multiple parallelism factors. The factoring system 420 can identify one or more of the partitioning schemes providing sped-up simulation relative to the single device simulation of the circuit design 401 and generate the parallelism factor message 403 to annunciate those identified partitioning schemes and optionally what simulator settings can be utilized to effectuate the partitioning schemes.

Referring back to FIGS. 3 and 5, when, in a block 505, additional partitioning schemes can be analyzed by the parallel simulation qualification system 400, execution returns to the block 504, where the parallel simulation qualification system 400 determines the expected performance of another one of the partitioning schemes.

When, in the block 505, no additional partitioning schemes can be analyzed by the parallel simulation qualification system 400, execution can proceed to a block 506, where the simulator 310 can partition the circuit design 301 using one of the partitioning schemes based on expected performances. In some embodiments, the parallel simulation qualification system 400 can generate a parallelism factor message 304 based on the expected performances, which can identify at least one of the partitioning schemes as providing a simulation speed-up. The parallelism factor message 304 can include a parallelism factor, which can correspond to an expected or predicted performance of a parallel simulation of the circuit design 301 using multiple processing devices of the computing system implementing the simulator 310. In some embodiments, the parallelism factor message 304 also can include commands that, when implemented by the simulator 310, can prompt compilation and simulation of the circuit design 301 with the identified partitioning scheme. The simulator 310 can, in some embodiments, iteratively invoke the parallelism profiler 316 with one partitioning scheme per invocation and utilize the resulting parallelism factor message 304 to identify at least one of the partitioning schemes as providing a simulation speed-up. The selectable simulation system 314 in the simulator 310, in a block 507, can simulate the partitions of the circuit design, at least partially in parallel, with multiple processing devices of the computing system. By performing parallel simulation qualification to identify possible partitioning schemes for the circuit design and simulation results from a single processing device simulation of the circuit design 301, a parallel simulation qualification system can determine whether a parallel simulation of the circuit design 301 would provide a speed-up over a single processing device simulation and, if so, which partitioning scheme to implement for a parallel simulation of the circuit design 301.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

### CONCLUSION

While the application describes specific examples of carrying out embodiments, those skilled in the art will appreciate that there are numerous variations and permutations of the above described systems and techniques that fall within the spirit and scope of the invention as set forth in the appended claims. For example, while some of the specific terminology has been employed above to refer to electronic design automation processes, it should be appreciated that various examples may be implemented using any electronic system.

One of skill in the art will also recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

1. A method comprising:
compiling, by a computing system, a circuit design describing an electronic device for simulation using a single processing device of the computing system, wherein the compilation of the circuit design identifies multiple different ways to partition the circuit design;
determining, for each of the different ways to partition the circuit design, an expected performance of the computing system using multiple processing devices to simulate the circuit design based, at least in part, on a simulation of the compiled circuit design with the single processing device of the computing system;
partitioning, by the computing system, the circuit design in one of the different ways based on the expected performance of the simulation of the circuit design; and
simulating, by the computing system, the partitions of the circuit design with the multiple processing devices of the computing system.

2. The method of claim 1, further comprising generating, by the computing system, a parallelism factor configured to identify the expected performance of the computing system using multiple processing devices to simulate the circuit design having been partitioned in at least one of the different ways.

3. The method of claim 1, wherein determining the expected performance of the computing system using the multiple processing devices includes:
determining an isolated performance for each of the multiple processing devices simulating partitions of the circuit design;
estimating a level of execution concurrency by the multiple processing devices simulating the partitions of the circuit design; and
determining a cost associated with synchronizing the multiple processing devices simulating the partitions of the circuit design, wherein the expected performance of the computing system using the multiple processing devices corresponds to the isolated performances of the multiple processing devices, the estimated level of execution concurrency and the cost associated with synchronizing the multiple processing devices.

4. The method of claim 1, further comprising simulating, by the computing system, the compiled circuit design with the single processing device of the computing system.

5. The method of claim 1, further comprising generating, by the computing system, a profile of a performance of the single processing device of the computing system during the simulation of the compiled circuit design, wherein determining, for each of the different ways to partition the circuit design, the expected performance of the computing system using multiple processing devices is based on the profile of the performance of the single processing device of the computing system.

6. The method of claim 5, wherein the profile of the performance of the single processing device of the computing system includes one or more of the different ways to partition the circuit design, an estimated simulation load for each partition of the circuit design, a synchronization overhead between the partitions of the circuit design, a data communication overhead between the partitions of the circuit design, a frequency and distribution of execution of processes and triggers, and relative concurrent activity between the partitions of the circuit design.

7. The method of claim 1, wherein each of the partitions of the circuit design is simulated on a different processing device of the computing system.

8. An apparatus comprising at least one computer-readable memory device storing instructions configured to cause one or more processing devices to perform operations comprising:
compiling a circuit design describing an electronic device for simulation using a single processing device of a computing system, wherein the compilation of the circuit design identifies multiple different ways to partition the circuit design;
determining, for each of the different ways to partition the circuit design, an expected performance of the computing system using multiple processing devices to simulate the circuit design based, at least in part, on a simulation of the compiled circuit design with the single processing device of the computing system;
partitioning the circuit design in one of the different ways based on the expected performance of the simulation of the circuit design; and
simulating the partitions of the circuit design with the multiple processing devices of the computing system.

9. The apparatus of claim 8, wherein the instructions are configured to cause one or more processing devices to perform operations further comprising generating a parallelism factor configured to identify the expected performance of the computing system using multiple processing devices to simulate the circuit design having been partitioned in at least one of the different ways.

10. The apparatus of claim 8, wherein determining the expected performance of the computing system using the multiple processing devices includes:
determining an isolated performance for each of the multiple processing devices simulating partitions of the circuit design;
estimating a level of execution concurrency by the multiple processing devices simulating the partitions of the circuit design; and
determining a cost associated with synchronizing the multiple processing devices simulating the partitions of the circuit design, wherein the expected performance of the computing system using the multiple processing devices corresponds to the isolated performances of the multiple processing devices, the estimated level of execution concurrency and the cost associated with synchronizing the multiple processing devices.

11. The apparatus of claim 8, wherein the instructions are configured to cause one or more processing devices to perform operations further comprising simulating the compiled circuit design with the single processing device of the computing system.

12. The apparatus of claim 8, wherein the instructions are configured to cause one or more processing devices to perform operations further comprising generating a profile of a performance of the single processing device of the computing system during the simulation of the compiled circuit design, wherein determining, for each of the different ways to partition the circuit design, the expected performance of the computing system using multiple processing devices is based on the profile of the performance of the single processing device of the computing system.

13. The apparatus of claim 12, wherein the profile of the performance of the single processing device of the computing system includes one or more of the different ways to partition the circuit design, an estimated simulation load for each partition of the circuit design, a synchronization overhead between the partitions of the circuit design, a data communication overhead between the partitions of the circuit design, a frequency and distribution of execution of processes and triggers, and relative concurrent activity between the partitions of the circuit design.

14. The apparatus of claim 8, wherein each of the partitions of the circuit design is simulated on a different processing device of the computing system.

15. A system comprising:
a memory system configured to store computer-executable instructions; and
a computing system, in response to execution of the computer-executable instructions, is configured to:
compile a circuit design describing an electronic device for simulation using a single processing device of a computing system, wherein the compilation of the circuit design identifies multiple different ways to partition the circuit design;
determine, for each of the different ways to partition the circuit design, an expected performance of the computing system using multiple processing devices to simulate the circuit design based, at least in part, on a simulation of the compiled circuit design with the single processing device of the computing system;
partition the circuit design in one of the different ways based on the expected performance of the simulation of the circuit design; and
simulate the partitions of the circuit design with the multiple processing devices of the computing system.

16. The system of claim 15, wherein the computing system, in response to execution of the computer-executable instructions, is further configured to generate a parallelism factor configured to identify the expected performance of the computing system using multiple processing devices to simulate the circuit design having been partitioned in at least one of the different ways.

17. The system of claim 15, wherein the computing system, in response to execution of the computer-executable instructions, is further configured to determine the expected performance of the computing system using the multiple processing devices by:
determining an isolated performance for each of the multiple processing devices simulating partitions of the circuit design;
estimating a level of execution concurrency by the multiple processing devices simulating the partitions of the circuit design; and
determining a cost associated with synchronizing the multiple processing devices simulating the partitions of the circuit design, wherein the expected performance of the computing system using the multiple processing devices corresponds to the isolated performances of the multiple processing devices, the estimated level of execution concurrency and the cost associated with synchronizing the multiple processing devices.

18. The system of claim 15, wherein the computing system, in response to execution of the computer-executable instructions, is further configured to:
generate a profile of a performance of the single processing device of the computing system during the simulation of the compiled circuit design; and
determine, for each of the different ways to partition the circuit design, the expected performance of the computing system using multiple processing devices based on the profile of the performance of the single processing device of the computing system.

19. The system of claim 18, wherein the profile of the performance of the single processing device of the computing system includes one or more of the different ways to partition the circuit design, an estimated simulation load for each partition of the circuit design, a synchronization overhead between the partitions of the circuit design, a data communication overhead between the partitions of the circuit design, a frequency and distribution of execution of processes and triggers, and relative concurrent activity between the partitions of the circuit design.

20. The system of claim 15, wherein each of the partitions of the circuit design is simulated on a different processing device of the computing system.
